(19) United States
(12) Patent Application Publication
(10) Pub. No.: US 2010/0046238 A1
(43) Pub. Date: Feb. 25, 2010

(54) Outer shell structure of a decoration lamp string

(76) Inventor: Hsiu-Tsen Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,042

(22) Filed: Aug. 22, 2008

(51) Int. Cl. F21S 13/10

(52) U.S. Cl. 362/363

(57) ABSTRACT

A kind of outer shell structure of a decoration lamp string mainly are two or more than two flowered shells linked together on a foundation, it is then jointed with a light bulb group which is sleeve-fit a lamp stand with a linking seat. The linking seat is internally connect-set with a light bulb. The said outer shell uses the foundation to be insert-connected with the linking seat and covers the light bulb to form an outer shell of light bulb with several flowered shell linking bodies such that the light of light bulb generates more light illustrating faces through this outer shell to let the light source generated by a single light bulk becomes more dazzling shining. Simultaneously, it is hard to be overheated due to the increasing space in covering light bulb, and its life of usage is increased.

### BACKGROUND OF THE INVENTION

The light bulb group of a known decoration lamp string generally includes a lamp stand, a linking seat and a light bulb that are composed as a unity. The light of a light bulb is utilized to exhibit the decoration or twinkling effects. But, this kind of structure is only illuminated out directly the light generated by the light bulb, and there is no specialty at all worthwhile to be mentioned. Thus, a kind of light bulb group covered with an outer shell that can generate dazzling shining effect is designed as the newer design described in the U.S. Pat. No. 7,325,942 which is a light bulb covered by an outer shell with a single flowered shell, and a solid arborescence branching body is formed on the outer shell. Through this, while the light bulb is lightening, the beam is passing through the flowered shell and generating a more dazzling light through the refraction of each branching body. However, the light of this kind of light bulb group is only illuminated out through the single flowered shell of outer shell. The generated illustrated face is also limited to the said face of the followed shell of outer shell. Furthermore, due to the small space covering the light bulb, the heat dissipation effect is bad and the light bulb is easy to be damaged unless a hole is opened in the flowered shell. But the beauty and expected effect will be damaged through doing this, thus it still waits to be improved.

### SUMMARY OF THE INVENTION

The present invention is a kind of outer shell structure of a decoration lamp string, which mainly uses two or more than two flowered shells to be linked together to form an outer shell of light bulb with several flowered shell linking bodies to let the light bulb generates more light illustrating faces. Simultaneously, it is hard to be overheated due to the increasing space of light bulb, thus the life of usage is increased and the practical effects are obtained. The structure and characteristics of the present invention are described hereafter by referring to following drawings.

### BRIEF DESCRIPTION OF THE DRAWINGS

FIG. 1 is a three dimension analytic drawing of the present invention.

FIG. 2 is a collocated drawing of the present invention.

FIG. 3 is a sectional drawing of the present invention.

FIG. 4 is an embodiment drawing of the present invention.

### DETAILED DESCRIPTION OF THE PREFERRED EMBODIMENT

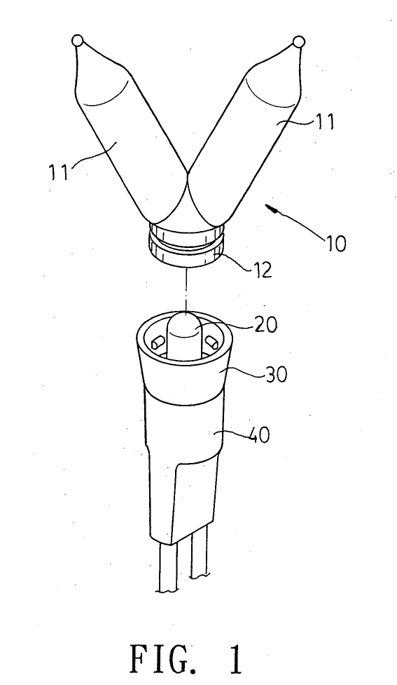

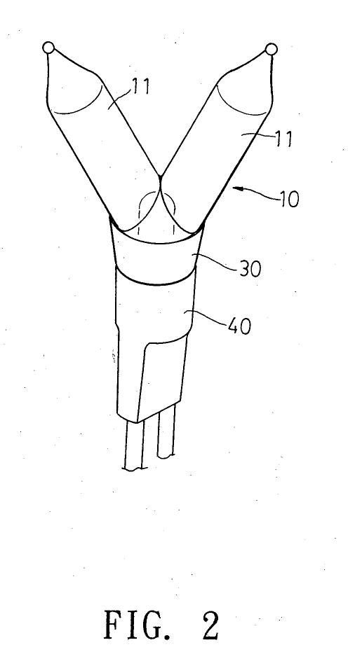

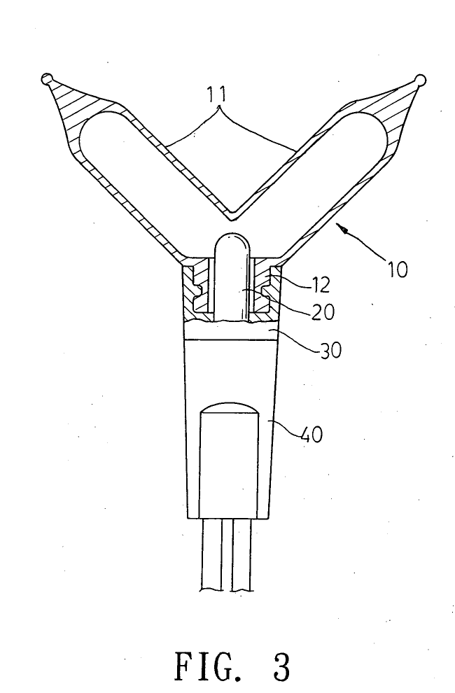

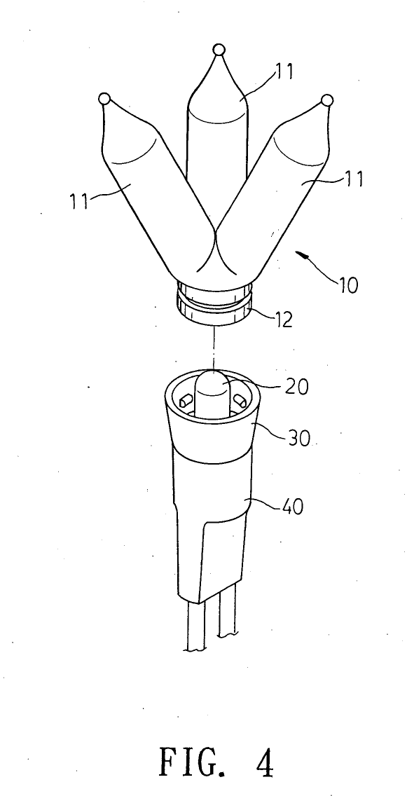

Please refer to those shown in FIG. 1 to 3. The present invention is related to a kind of outer shell structure of the decoration lamp string, which mainly is a design using an outer shell 10 sleeve-fit on the outside of the light bulb 20 in the light bulb group. The light bulb group includes a lamp stand 40 to be sleeve-fit with a linking seat 30, and the light bulb 20 is then set in the kinking seat 30. The said light bulb can be a normal light bulb or a LED light bulb. The aforementioned outer shell 10 are two or more than two hollow flowered shells 11 linked together on the same foundation 12, wherein the flowered shell 11 can be long circular, circular or any other shapes, and the outside surface of flowered shell 11 can be made with all kinds of textures and has a design with light penetrating ability. The outer shell 10 is insert-set-locked by its foundation 12, and it is hooked up in the linking seat 30 and covers the bulb 20. And, the lock-hooking method between the outer shell 10 and the linking seat 30 is not limited to any forms. Those shown in FIG. 4 is an implementing form of an outer shell 10 in the present invention that uses three hollow flowered shell 11 linking bodies to be linked on the same foundation 12.

Through the aforementioned design, each light bulb group in the decoration lamp string all set with a light bulb 20 covered by an outer shell 10 with several flowered shells 11 linking bodies such that the light lightened by the light bulb 20 is illustrated out through each flowered shell 11 by this outer shell, and more light illustrating faces can be generated to let the light source generated by a single light bulk 20 becomes more dazzling shining. Simultaneously, it is hard to be overheated due to the design of several hollow flowered shells 11 which can increase the space in covering light bulb, and its life of usage is thus increased.

However, the aforementioned are only demonstrative examples in the present invention, and are not used to restrict the range of the present invention. Thus, all modification implemented under the same creative originality shall be covered by the present invention.

I claim:

1. A kind of outer shell structure of a decoration lamp string mainly including two or more than two hollow flowered shells linked together on a foundation, wherein it is jointed with a light bulb group being sleeve-fit a lamp stand with a linking seat, and it is locked and hooked up with the linking seat through the foundation, and it is covered and connect-set on the outside of the bulb in the linking seat.

2. A kind of outer shell structure of a decoration lamp string as claimed in claim 1, wherein the flowered shell can be long circular, circular, and the outside surface of flowered shell can be set with texture and has the light penetrating ability.
